(19) United States
(12) Patent Application Publication
(10) Pub. No.: US 2025/0252280 A1
(43) Pub. Date: Aug. 7, 2025

(54) MAGNETIC STRIPE TRACK SIGNAL HAVING MULTIPLE COMMUNICATIONS CHANNELS

(71) Applicant: Dynamics Inc., Cheswick, PA (US)

(72) Inventor: Jeffrey D. Mullen, Glenshaw, PA (US)

(21) Appl. No.: 19/184,609

(22) Filed: Apr. 21, 2025

Related U.S. Application Data
(63) Continuation of application No. 14/243,009, filed on Apr. 2, 2014, now Pat. No. 12,282,819.
Application No. 14/243,009 is a continuation of application No. 12/902,254, filed on Oct. 12, 2010, now Pat. No. 8,727,219.
(60) Provisional application No. 61/250,636, filed on Oct. 12, 2009.

(51) Int. Cl. G06K 19/06; G06K 7/08

(52) U.S. Cl. CPC G06K 19/06196; G06K 7/083; G06K 7/087

(57) ABSTRACT

An electronic card (e.g., an electronic payment card) or another device (e.g., a wireless telephonic device) is provided that may communicate dynamic magnetic stripe data to a magnetic stripe reader. Information may be embedded into a magnetic track of data representative of additional information such as, for example, a unique identification number or an additional track of magnetic stripe data.

### CROSS-REFERENCE TO RELATED APPLICATION

This application claims the benefit of U.S. patent application Ser. No. 14/243,009, titled “MAGNETIC STRIPE TRACK SIGNAL HAVING MULTIPLE COMMUNICATIONS CHANNELS,” filed Apr. 2, 2014, issued as U.S. Pat. No. 12,282,819 on Apr. 22, 2025, which claimed priority to U.S. patent application Ser. No. 12/902,254, titled “MAGNETIC STRIPE TRACK SIGNAL HAVING MULTIPLE COMMUNICATIONS CHANNELS,” filed Oct. 12, 2010, issued as U.S. Pat. No. 8,727,219 on May 14, 2014, which claimed priority to Provisional Patent Application No. 61/250,636, titled “Magnetic Stripe Track Signal Having Multiple Communications Channels,” filed Oct. 12, 2009, now expired, all of which are hereby incorporated by reference herein in its entirety.

### BACKGROUND OF THE INVENTION

This invention relates to magnetic cards and devices and associated payment systems.

### SUMMARY OF THE INVENTION

A card may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

All, or substantially all, of the front as well as the back of a card may be a display (e.g., bi-stable, non bi-stable, LCD, LED, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. Accordingly, a barcode may be displayed across all, or substantially all, of a surface of a card. In doing so, computer vision equipment such as barcode readers may be less susceptible to errors in reading a displayed barcode.

A card may include a number of output devices to output dynamic information. For example, a card may include one or more RFIDs or IC chips to communicate to one or more RFID readers or IC chip readers, respectively. A card may include devices to receive information. For example, an RFID and IC chip may both receive information and communicate information to an RFID and IC chip reader, respectively. A device for receiving wireless information signals may be provided. A light sensing device or sound sensing device may be utilized to receive information wirelessly. A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and a sound sensing device). A processor may be coupled to surface contacts such that the processor may perform the processing capabilities of, for example, an EMV chip. The processor may be laminated over and not exposed such that such a processor is not exposed on the surface of the card.

A magnetic stripe reader is provided that is operable to extract bit information from flux transversals. Such a magnetic stripe reader may do so, for example, by utilizing frequency/double-frequency decoding of a signal provided by a magnetic stripe. The reader may extract additional information from such a magnetic stripe signal. For example, the reader may utilize differences in magnitude of flux transversals to discern additional data. Accordingly, a card may include a dynamic magnetic stripe communications device operable to communicate magnetic stripe data by communicating data through a frequency/double-frequency encoding scheme and also by changing the magnitude of such a signal to various levels for particular flux transversals of the signal. Additional data may be provided in such a signal (e.g., a magnetic stripe track signal). For example, the slope that a particular signal increases and decreases may be controlled by a dynamic magnetic stripe communications device such that, for example, a magnetic stripe reader operable to discern such varying slopes as particular data may be operable to extract such varying slopes as particular data. In this manner, a magnetic stripe reader is provided that is operable to discern data from a magnetic stripe signal other than just the timing between flux transversals and use this discerned data as additional information. Similarly, an electronic payment card is provided that is operable to communicate a stream of magnetic data with embedded information.

A remote facility is provided that is operable to receive an enhanced data packet from a magnetic stripe reader and utilize this additional data to perform additional functions. Particularly, the remote facility may receive data indicative of a magnetic stripe track as well as data representative of additional, embedded information. Such a remote facility may receive, for example, information and embedded information from multiple tracks (e.g., two or three tracks).

A magnetic stripe reader is provided that is operable to extract information from characteristics of a magnetic stripe signal in addition to the timing between flux transversals. For example, a magnetic stripe reader may determine levels of the amplitude of magnetic-based signals at particular data points (e.g., the 10^{th} bit of data) and utilize this additional information to discern an additional bit of information. The reader may then send such additional information from a stripe signal to a remote server in addition to the information extracted from the timing of the flux transversals themselves. This additional information may be utilized, for example, to verify the authenticity of a card for a particular account number (e.g., a card-controlled “signature” for the stripe), to transmit information associated with the status of the card (e.g., voltage of a battery or tamper status of tamper detecting hardware/software), to transmit information associated with the card's environment (e.g., the number of swipes of a card in a predetermined time such as the 60 seconds prior to data transmission), or to transmit any additional information (e.g., a second or a second and third magnetic stripe track of data). Accordingly, for example, a single track of magnetic stripe data may include enough embedded information to provide a total of three tracks of magnetic stripe data.

A dynamic magnetic stripe reader communications device is provided. Such a communications device may take the form of a magnetic encoder operable to write data to a magnetic medium. Such a communications device may take the form of a magnetic emulator operable to transmit data directly to a read-head of a read-head housing of a magnetic stripe reader without the presence of a magnetic stripe.

A magnetic stripe may be provided over a magnetic emulator. A magnetic stripe may include a magnetic signature. A reader may determine the magnetic signature from this magnetic stripe by reading, for example, variations in amplitude of magnetic-based signals at particular data points/ranges. The reader may then communicate an additional field of data with a number corresponding to this signature. A remote server may, for example, check an account number transmitted in the base information to determine whether the card is in a registry of cards that opted-in for signature authentication and, if so, the remote server may check the value of the extended data to determine whether it is in a range of values stored for that particular card. If so, the transaction may be verified. If not, the transaction may be refused.

A magnetic stripe emulator may be provided without a magnetic stripe. A magnetic stripe emulator may include one or more coils that correspond to one or more tracks of data. Accordingly, three coils may be provided to send a separate track of data to a separate read-head of a single read-head housing. A processor of a card may, for example, determine additional information to communicate (e.g., a dynamic signature or additional information). The processor may change the amount of current provided through a particular coil at a particular time (e.g., when a particular bit is being transmitted) such that additional data is communicated to the reader. For example, a reader may look at the amplitude of received signals for particular bits (or groups of bits) and discern information depending on the amplitude received. For example, a bit may be discerned from a determination that a particular part of the signal is HI or LOW. More information may be discerned from a determination that a particular part of the signal is HI, MEDIUM, or LOW.

Information may also be transmitted, for example, by comparing characteristics of different tracks to each other. For example, two coils may be provided. If the processor communicates each track at the same frequency, then one bit of information may be discerned. If the processor communicates each track at different frequencies, then another bit of information may be discerned. Accordingly, a track of information may be utilized as a base frequency and the frequencies of the other tracks, compared to this base track, may be utilized to discern additional information. For example, if twenty frequencies can be discerned by a reader then, for example, twenty additional states of information may be discerned by the reader if two tracks are communicated.

Such techniques may allow, for example, for one track of data to be embedded into another track of data without extending the length of that other track of data. For example, track 2 data may be embedded into track 1 data. In doing so, a multi-track signal may be provided within a single track. Accordingly, a magnetic stripe emulator may be provided that is operable to wirelessly communicate a track of magnetic stripe data to a reader. Accordingly, a remote server may receive a track of base data with an extended data field and utilize this extended data field as an additional track of data. Accordingly, the remote server may parse the second track of data and send portions of that track of data to different remote servers (e.g., one portion may be communicated to a remote processing facility controlled by a card association and another portion may be communicated to a remote processing facility controlled by a card issuer). Accordingly, embedding information into a magnetic stripe track signal may, for example, allow additional information to be communicated without extending the length of the magnetic stripe track signal.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of cards constructed in accordance with the principles of the present invention;

FIG. 2 is an illustration of communication signals constructed in accordance with the principles of the present invention;

FIG. 3 is an illustration of communication signals constructed in accordance with the principles of the present invention;

FIG. 4 is an illustration of communication signals constructed in accordance with the principles of the present invention;

FIG. 5 is an illustration of a magnetic stripe reader and card constructed in accordance with the principles of the present invention; and

FIG. 6 is an illustration of processes constructed in accordance with the principles of the present invention.

### DETAILED DESCRIPTION OF THE INVENTION

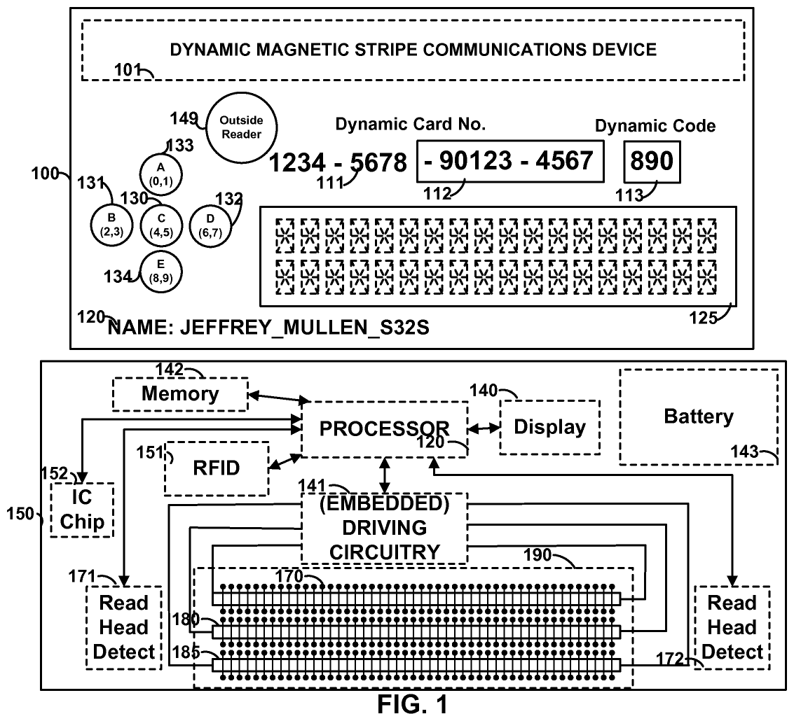

FIG. 1 shows card 100 that may include, for example, a dynamic number that may be entirely, or partially, displayed via display 112. A dynamic number may include a permanent portion such as, for example, permanent portion 111. Permanent portion 111 may be printed as well as embossed or laser etched on card 100. Multiple displays may be provided on a card. For example, display 113 may be utilized to display a dynamic code such as a dynamic security code. Display 125 may also be provided to display logos, barcodes, as well as multiple lines of information. A display may be a bi-stable display or non bi-stable display. Permanent information 120 may also be included and may include information such as information specific to a user (e.g., a user's name or username) or information specific to a card (e.g., a card issue date and/or a card expiration date). Card 100 may include one or more buttons such as buttons 130-134. Such buttons may be mechanical buttons, capacitive buttons, or a combination of mechanical and capacitive buttons. Card 100 may include button 149. Button 149 may be used, for example, to place card 100 into a programming mode to receive programming (e.g., programming of a user's personal payment card data). A button (e.g., button 149) may be utilized in a variety of ways (e.g., to communicate information through a dynamic magnetic communications device indicative of a user's intent to purchase a particular product with points instead of credit). Button 149 may be provided to, for example, instruct the card to communicate data in a form desired for a wireless transmission through the casing of a magnetic stripe reader instead of, for example, a swiping of the card past a magnetic stripe reader read-head housing. In doing so, for example, multiple tracks of information (e.g., one or two tracks of information) may be embedded into a different track that is communicated. In doing so, for example, a single read-head of a read-head housing may receive the magnetic track signal having embedded information representative of additional magnetic stripe tracks, discern these different tracks, and communicate these different tracks to a remote facility.

Architecture 150 may be utilized with any card. Architecture 150 may include processor 120. Processor 120 may have on-board memory for storing information (e.g., application code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120. Memory 142 may be coupled to processor 120. Memory 142 may include data that is unique to a particular card. For example, memory 142 may store discretionary data codes associated with buttons of card 150. Such codes may be recognized by remote servers to effect particular actions. For example, a code may be stored on memory 142 that causes a non-merchant product to be purchased with points during a merchant transaction. Memory 142 may store, for example, data to be embedded into a magnetic stripe track signal.

Any number of reader communication devices may be included in architecture 150. For example, IC chip 152 may be included to communicate information to an IC chip reader. IC chip 152 may be, for example, an EMV chip. As per another example, RFID 151 may be included to communicate information to an RFID reader. A magnetic stripe communications device may also be included to communicate information to a magnetic stripe reader. Such a magnetic stripe communications device may provide electromagnetic signals to a magnetic stripe reader. Different electromagnetic signals may be communicated to a magnetic stripe reader to provide different tracks of data. For example, electromagnetic field generators 170, 180, and 185 may be included to communicate separate tracks of information to a magnetic stripe reader. Such electromagnetic field generators may include a coil wrapped around one or more materials (e.g., a soft-magnetic material and a non-magnetic material). Each electromagnetic field generator may communicate information serially to a receiver of a magnetic stripe reader for a particular magnetic stripe track. Read-head detectors 171 and 172 may be utilized to sense the presence of a magnetic stripe reader (e.g., a read-head housing of a magnetic stripe reader). This sensed information may be communicated to processor 120 to cause processor 120 to communicate information serially from electromagnetic generators 170, 180, and 185 to magnetic stripe track receivers in a read-head housing of a magnetic stripe reader. Accordingly, a magnetic stripe communications device may change the information communicated to a magnetic stripe reader at any time. Processor 120 may, for example, communicate user-specific and card-specific information through RFID 151, IC chip 152, and electromagnetic generators 170, 180, and 185 to card readers coupled to remote information processing servers (e.g., purchase authorization servers). Driving circuitry 141 may be utilized by processor 120, for example, to control electromagnetic generators 170, 180, and 185. Driver circuitry 141 may change characteristics of a magnetic stripe track in order to embed additional information into that track. Similarly, for example, driver circuitry 141 may change characteristics of two, or more, magnetic stripe tracks in order to embed information between characteristics of such magnetic stripe tracks.

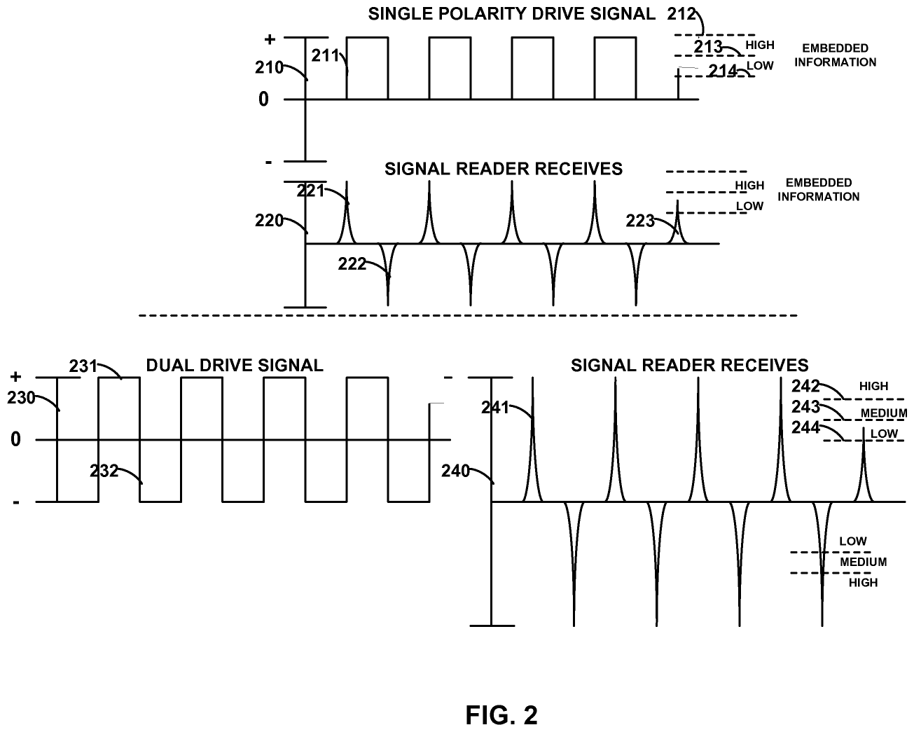

FIG. 2 shows signal 210 that may include signal segment 211. A magnetic emulator may, for example, be driven to produce flux transversals operable to be read by a magnetic stripe reader. The magnitude of the signal may, for example, be controlled. Particularly, the magnitude of a signal may be provided between thresholds 212 and 213 to embed one particular information and the magnitude of that signal may be provided between thresholds 213 and 214 to embed different information. Accordingly, for example, a HIGH state and a LOW state may be provided by a dynamic magnetic stripe communications device (e.g., a magnetic emulator) and this HIGH and LOW state may be discerned by a magnetic stripe reader and utilized to communicate additional information. Persons skilled in the art will appreciate that the magnitude of current provided through, for example, a coil of a magnetic emulator may be indicative of the magnitude of the electromagnetic signal provided by that coil.

Signal 220 may also be provided that includes signal segments 221 and 222. A magnetic stripe reader may, for example, receive flux transversals as segments 221 and 222. Signal 210 may be provided at a single polarity. Signal 220 may also be included that includes signal segment 221. For example, segment 221 may be obtained as a result of an increase of signal 210. Signal segment 222 may be obtained as the result of a decrease of signal 210. Signal segment 223 may have, for example, a lower magnitude than signal segment 221 and, as a result, additional information may be communicated through this difference in magnitude.

Persons skilled in the art will appreciate that cards may be pre-set with different magnitudes to communicate different portions of one or more tracks of magnetic stripe data. Such presets may be unique for each card. In doing so, for example, the identity of a card may be obtained regardless of the information that is communicated.

Signal 230 may be provided. Signal 230 may be, for example, a dual polarity drive signal for driving, for example, a magnetic emulator. Segments 231 and 232 may be provided on signal 230. A read-head of a magnetic stripe reader may receive signal 240 from a magnetic emulator driven via signal 230. Accordingly, segment 241 may be provided. Thresholds 242, 243, and 244 may be utilized, for example, to extract additional information from a signal (e.g., a magnetic stripe track signal). For example, thresholds 242, 243, and 244 may be utilized to define LOW, MEDIUM, and HIGH states, where each state may represent different information. For signal segments of the opposite polarity, similar thresholds may be provided to provide additional states of LOW, MEDIUM, and HIGH. Persons skilled in the art will appreciate that any number of thresholds may be utilized to provide any number of states.

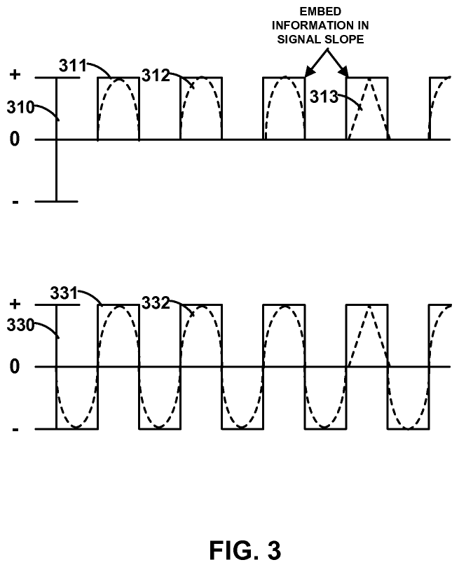

FIG. 3 shows signal 310 having signal segment 311. Persons skilled in the art will appreciate that the slope of a signal may be changed. For example, the slope of a signal may be changed from a discrete change to a non-linear slope (e.g., slope 312) on one or more sides of a pulse or a linear slope (e.g., slope 313) on one or more sides of a pulse (or a combination). Such differences in slopes may be determined by a reader and, for example, utilized by the reader to extract additional bits of information. Signal 330 shows signal 331 that also may utilize varying slopes (e.g., slope 332) to embed additional information into an information signal such as a magnetic stripe track signal communicated in a frequency/double-frequency encoding scheme (e.g., F2F encoding).

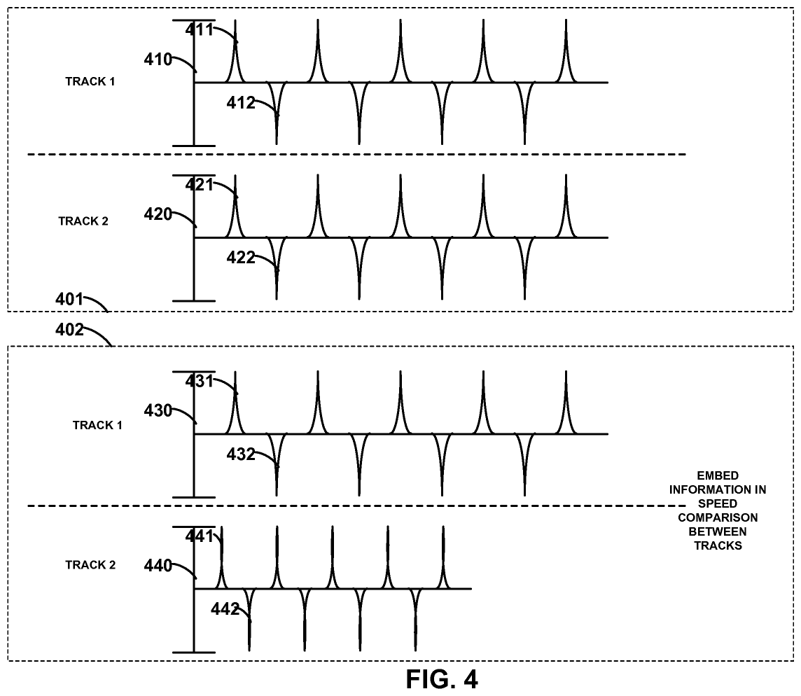

FIG. 4 shows magnetic stripe data 401 as being read by a magnetic stripe reader having multiple read-heads receiving magnetic stripe track data. As shown, the received data includes magnetic stripe track data 410 and magnetic stripe track data 420. Data may be embedded by changing characteristics of one track data with respect to the other track data. For example, a dynamic magnetic stripe communications device may introduce a delay between when two track signals are communicated. This delay, for example, may be utilized to communicate additional information. Such delays may be included in each pulse of information so that a magnetic stripe reader may notice the delays to extract additional information, but which may be transparent to a frequency/double frequency (e.g., F2F) encoding scheme. Magnetic stripe signal 402 shows additional data being read by a magnetic stripe reader. The additional data can include magnetic stripe track signal 430 and 440. Segments 431 and 432 may be included in signal 430. Segments 441 and 442 may be included in signal 440. Information may be embedded, for example, by changing the overall speed that one track is communicated with respect to the other track.

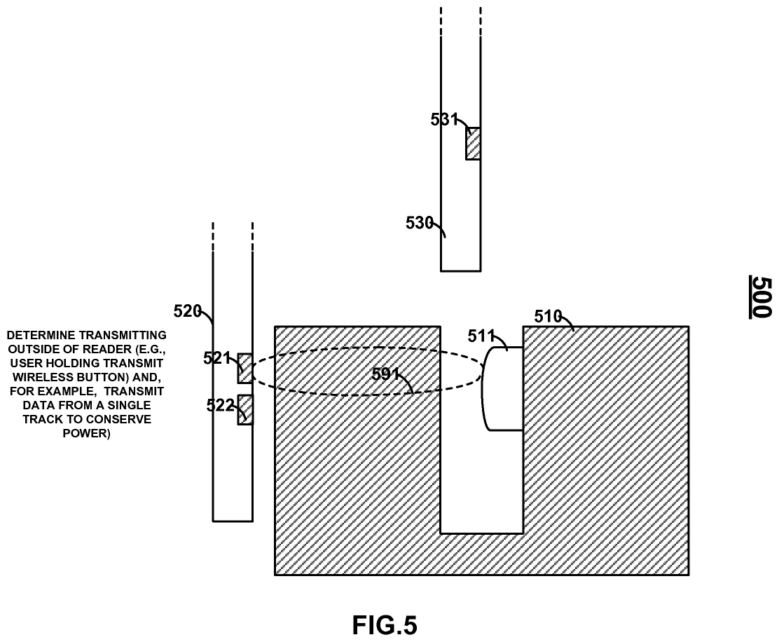

FIG. 5 shows topology 500. Card 530 may include a dynamic magnetic stripe communications device for communicating one or more tracks of magnetic stripe data to a read-head (e.g., read-head 511) of a magnetic stripe reader (e.g., magnetic stripe reader 510). Card 520 may include magnetic stripe communications device 521 and 522. Device 521 may communicate information via, for example, electromagnetic signal 591. Persons skilled in the art will appreciate that card 520 may determine whether to communicate information outside or inside a reader via, for example, a manual button. Device 521 may, for example, communicate a single track of data if card 520 is swiped. However, device 520 may communicate multiple tracks of information (e.g., one track embedded in another track) if the card is desired to communicate outside of a reader. Device 520 may be included in a wireless telephonic device.

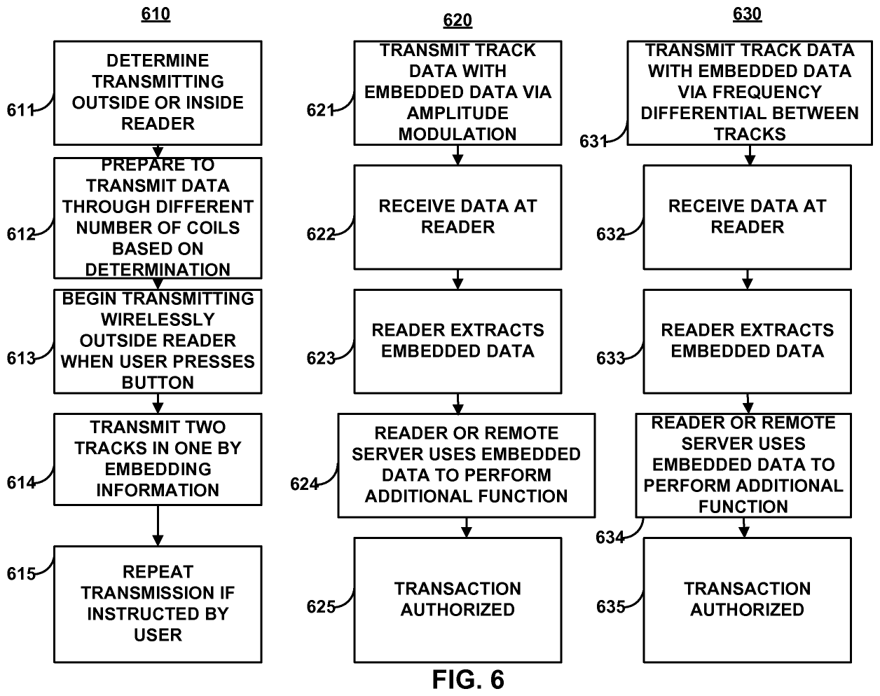

FIG. 6 shows flow charts 610, 620, and 630. Flow chart 610 includes step 611, in which a determination is made as to whether a magnetic stripe transmission is desired to be communicated outside or inside of a reader. Step 612 may be included, in which data is prepared to be transmitted through one or more coils based on the determination of step 611. In step 613, data may be communicated wirelessly, while the card is positioned outside of a reader, when a button is pressed on the card. Step 614 may be provided, in which multiple tracks (e.g., two) are communicated in a single track via embedded information into a magnetic stripe track signal. The transmission may be repeated, for example, in step 615.

Flow chart 620 may be provided that may include step 621, in which data may be communicated with data embedded in the amplitude of the signal. Such data may be received at a reader in step 622 and the embedded data may be extracted in step 623. The extracted embedded data may be utilized to perform an additional function in step 624 and the transaction may be authorized in step 625.

Flow chart 630 may be provided and may include step 631, in which data may be embedded into track data via frequency differentials between tracks (e.g., speed differentials between tracks). Step 632 may be provided in which data is received at a reader. The reader may extract embedded data in step 633 and this data may be utilized to perform additional functions in step 634. A transaction may be authorized in step 635.

Persons skilled in the art will also appreciate that the present invention is not limited to only the embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

What is claimed is:

1. A card comprising: a battery; a processor; a magnetic emulator including at least two coils, wherein each coil is operable to communicate a separate track of magnetic stripe data; wherein the card is operable to embed additional information by varying frequencies communicated simultaneously through the at least two coils, enabling a magnetic stripe reader to discern the embedded additional information from frequency differentials between the tracks.

2. A card comprising: a battery; a processor; a magnetic emulator configured to generate an electromagnetic signal including multiple tracks of magnetic stripe data; wherein the magnetic emulator is operable to communicate each track at different frequencies simultaneously; wherein the magnetic emulator is operable to embed additional data within the electromagnetic signal by comparing frequency differentials between at least two tracks of magnetic stripe data, such that a magnetic stripe reader is operable to extract the additional data based on the frequency differential between the communicated tracks.

3. A magnetic stripe reader comprising: a read-head configured to read magnetic stripe signals; wherein the magnetic stripe reader is operable to decode first magnetic stripe track data from flux transversal timings and operable to decode additional data from slope variations in the signal's electromagnetic waveform associated with at least one flux transversal.

4. The card of claim 1, wherein the additional information includes card-specific identification data.

5. The card of claim 1, further comprising a capacitive touch screen display operatively coupled to the processor.

6. The card of claim 1, wherein the frequency differentials represent different user-defined transaction modes.

7. The card of claim 1, wherein the processor is laminated within the card such that the processor is not exposed on the card's surface.

8. The card of claim 1, wherein the processor controls current amplitude through the coils to vary the magnitude of electromagnetic signals communicated.

9. The card of claim 2, wherein the additional data includes transaction authorization data.

10. The card of claim 2, wherein the additional data includes environmental data collected by sensors integrated within the card.

11. The card of claim 2, wherein the magnetic emulator is further operable to transmit the embedded additional data to a remote server for verification.

12. The card of claim 2, wherein embedding additional data includes embedding second track data into first track data without extending the length of the first track data.

13. The reader of claim 3, wherein the slope variations comprise linear and non-linear slopes.

14. The reader of claim 3, wherein the additional data decoded from slope variations includes a verification signature unique to the card.

15. The reader of claim 3, operable to transmit decoded additional data to a remote transaction verification server.

16. The card of claim 1, wherein the additional information includes a dynamic security code.

17. The card of claim 1, wherein the card further comprises an RFID chip communicatively coupled to the processor.

18. The card of claim 1, wherein the magnetic emulator communicates magnetic stripe data without the presence of a physical magnetic stripe.

19. The reader of claim 3, wherein the electromagnetic waveform is received as a dual polarity signal.

20. The reader of claim 3, wherein the electromagnetic waveform is received as a single polarity signal.
